(19) United States
(12) Patent Application Publication
(10) Pub. No.: US 2023/0128073 A1
(43) Pub. Date: Apr. 27, 2023

(54) ALL-SOLID SECONDARY BATTERY

(71) Applicant: SAMSUNG SDI CO., LTD., Yongin-si (KR)

(72) Inventors: Minsuk LEE, Yongin-si (KR); Suyeol RYU, Yongin-si (KR); Hongjeong KIM, Yongin-si (KR); Younggyoon RYU, Yongin-si (KR); Jaegu YOON, Yongin-si (KR)

(21) Appl. No.: 17/972,695

(22) Filed: Oct. 25, 2022

(30) Foreign Application Priority Data
Oct. 25, 2021 (KR) 10-2021-0143074

(51) Int. Cl. H01M 10/42; H01M 10/0585

(52) U.S. Cl. CPC H01M 10/4235; H01M 10/0585

(57) ABSTRACT

An all-solid secondary battery includes a cathode layer, an anode layer, and a solid electrolyte layer disposed between the cathode layer and the anode layer. The cathode layer includes a cathode active material layer and a flame-retardant inactive member located on and in contact with the solid electrolyte layer and has a rectangular enclosure shape surrounding side surfaces of the cathode active material layer, wherein the flame-retardant inactive member includes a pair of first side portions and a pair of second side portions connected to the first side portions, the first side portions having uncoated portion corresponding portions corresponding to a cathode uncoated portion of a cathode current collector and an anode uncoated portion of an anode current collector, respectively, and wherein a width of the uncoated portion corresponding portion of the first side portion is greater than a width of the remaining portion of the first side portion.

### CROSS-REFERENCE TO RELATED APPLICATION

This application is based on and claims priority under 35 U.S.C. § 119 to Korean Patent Application No. 10-2021-0143074, filed on Oct. 25, 2021, in the Korean Intellectual Property Office, the disclosure of which is incorporated by reference herein in its entirety.

### BACKGROUND

### 1. Field

Embodiments relate to an all-solid secondary battery.

### 2. Description of the Related Art

In line with recent requirements in the industry, batteries with high energy density and stability are actively being developed. For example, lithium-ion batteries are commercialized not only in the fields related to information-related devices and communication devices, but also in the automobile industry. In the automobile industry, safety is greatly emphasized as it is related to human life.

For example, lithium-ion batteries may include a liquid electrolyte. However, the liquid electrolyte may contain flammable organic solvent, and thus in the event of a short-circuit, may undergo overheating and cause fire. Therefore, batteries using a solid electrolyte (instead of a liquid electrolyte) have been considered.

Batteries using a solid electrolyte do not use flammable organic solvents, and thus even in the event of a short-circuit, can greatly decrease the risk of fire or explosion. Therefore, such all-solid secondary batteries can have remarkably increased safety compared to lithium ion batteries using liquid electrolytes.

### SUMMARY

According to embodiments, there is provided an all-solid secondary battery including a cathode layer; an anode layer; and a solid electrolyte layer between the cathode layer and the anode layer, wherein the cathode layer includes a cathode current collector, a cathode active material layer positioned on one surface or opposing both surfaces of the cathode current collector and a flame-retardant inactive member in a rectangular enclosure shape surrounding side surfaces of the cathode active material layer, wherein the cathode current collector includes a cathode uncoated portion composed of an exposed portion of the cathode current collector without the cathode active material layer disposed thereon, wherein the anode layer includes an anode current collector and an anode active material layer disposed on the anode current collector and here, the anode current collector includes an anode uncoated portion composed of an exposed portion of the anode current collector without the anode active material layer disposed thereon, wherein the flame-retardant inactive member, which is disposed on and in contact with the solid electrolyte layer, wherein the flame-retardant inactive member includes a pair of first side portions, each having an uncoated portion corresponding portion corresponding to the cathode uncoated portion and the anode uncoated portion, and a pair of second side portions connected to the first side portions, and wherein in the first side portion, a width of the uncoated portion corresponding portion is greater than a width of the remaining portion of the uncoated portion corresponding portion.

### BRIEF DESCRIPTION OF THE DRAWINGS

Features will become apparent to those of skill in the art by describing in detail exemplary embodiments with reference to the attached drawings, in which:

FIG. 1 is a cross-sectional view of an all-solid secondary battery according to an exemplary embodiment.

FIG. 2 is a cross-sectional view of a bi-cell all-solid secondary battery according to an exemplary embodiment.

FIG. 3 is a cross-sectional view of a bi-cell all-solid secondary battery according to an exemplary embodiment.

FIG. 4 is an exploded perspective view of an all-solid secondary battery according to an exemplary embodiment.

FIG. 5A is a front view showing an arrangement of a cathode layer and a flame-retardant inactive member in an all-solid secondary battery according to an exemplary embodiment.

FIG. 5B is an expanded view showing a part of an all-solid secondary battery according to an exemplary embodiment.

FIG. 6 illustrates a flame-retardant inactive member used in an all-solid secondary battery according to an exemplary embodiment.

FIG. 7 shows sequences of placement of a flame-retardant inactive member illustrated in FIG. 6 on an anode layer.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Like reference numerals refer to like elements throughout.

As used herein, the term “and/or” includes any and all combinations of one or more of the associated listed items. Expressions such as “at least one of,” when preceding a list of elements, modify the entire list of elements and do not modify the individual elements of the list.

The terminology used herein is for the purpose of describing particular embodiments only and is not intended to be limiting. As used herein, the singular forms “a,” “an” and “the” are intended to include the plural forms as well, unless the context clearly indicates otherwise. As used herein, the terms “comprises” and/or “comprising,” or “includes” and/or “including” when used in this specification, specify the presence of stated features, regions, integers, steps, operations, elements, components, ingredients, materials, or combinations thereof, but do not preclude the presence or addition of one or more other features, regions, integers, steps, operations, elements, components, ingredients, materials, or combinations thereof. As used herein, “/” may be interpreted as “and”, or as “or” depending on the context.

It will be understood that, although the terms “first,” “second,” etc. may be used herein to describe various elements, these elements should not be limited by these terms. These terms are only used to distinguish one element from another element.

Hereinbelow, an all-solid secondary battery according to exemplary embodiments will be described in greater detail.

[All-Solid Secondary Battery]

An all-solid secondary battery according to an embodiment may include a cathode layer; an anode layer; and a solid electrolyte layer between the cathode layer and the anode layer, wherein the cathode layer includes a cathode current collector, a cathode active material layer disposed on one surface or opposing both surface of the cathode current collector and a flame-retardant inactive member in a rectangular enclosure shape surrounding side surfaces of the cathode active material layer, wherein the cathode current collector includes a cathode uncoated portion composed of an exposed portion of the cathode current collector without the cathode active material layer disposed thereon, wherein the anode layer includes an anode current collector and an anode active material layer disposed on the anode current collector and here, the anode current collector includes an anode uncoated portion composed of an exposed portion of the anode current collector without the anode active material layer disposed thereon, wherein the flame-retardant inactive member which is located on and in contact with the solid electrolyte layer, wherein the flame-retardant inactive member includes a pair of first side portions, each having an uncoated portion corresponding portion corresponding to the cathode uncoated portion and the anode uncoated portion, and a pair of second side portions connected to the first side portions, and wherein in the first side portion, a width of the uncoated portion corresponding portion greater than a width of the remaining portion of the first side portion.

In detail, all-solid secondary batteries, e.g., all-solid secondary batteries containing sulfide-based solid electrolyte, may require a certain compression during manufacturing and charge/discharge testing. That is, since the electrolyte is solid, failing to maintain sufficient contact between the solid electrolyte layer and the cathode layer and between the solid electrolyte layer and the anode layer may increase resistance inside a battery. In order to increase the contact between the anode layer and solid electrolyte, the manufacturing process of an all-solid secondary battery includes a pressing process. During the pressing process, in a stack including a cathode layer, an anode layer, and a solid electrolyte layer, a pressure difference is produced in partially unstacked portions.

However, such pressure difference may cause micro-defects and non-uniformity inside a cell in the solid electrolyte layer. During charging/discharging of an all-solid secondary battery, such micro-defects and non-uniformity may cause cracks to form and propagate in the solid electrolyte layer, and lithium growth through such cracks may give rise to short circuits of the cathode layer and the anode layer.

In contrast, an all-solid secondary battery according to embodiments may prevent short circuits during charging/discharging, improve energy density and service life characteristics, and improve cell safety by including a flame-retardant inactive member of a particular structure. That is, by incorporating a flame-retardant inactive member of a certain structure into the outer edge of a cathode layer, an all-solid secondary battery according to an embodiment may provide uniform compression during the cell manufacturing and evaluation, thus suppressing cracking of a solid electrolyte layer and therefore can suppress short circuits in the all-solid secondary battery. Further, the flame-retardant inactive member incorporated in the all-solid secondary battery may prevent oxidation of lithium precipitated during charging/discharging by absorbing residual impurities and may improve cell stability by imparting flame retardancy. Furthermore, the use of a flame-retardant inactive member of a certain structure may reduce the level of difficulty of the stacking process of the member.

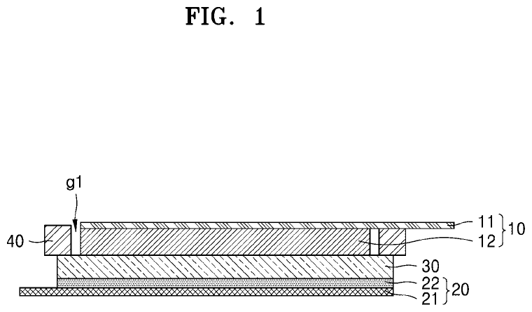

Referring to FIG. 1, an all-solid secondary battery 1 according to one embodiment may include a cathode layer 10, an anode layer 20, and a solid electrolyte layer 30 disposed between the cathode layer 10 and the anode layer 20. The cathode layer 10 may include a cathode current collector 11 and a cathode active material layer 12 on one surface or both surfaces of the cathode current collector 11, and the anode layer 20 may include an anode current collector 21 and an anode active material layer 22 located on the anode current collector 21.

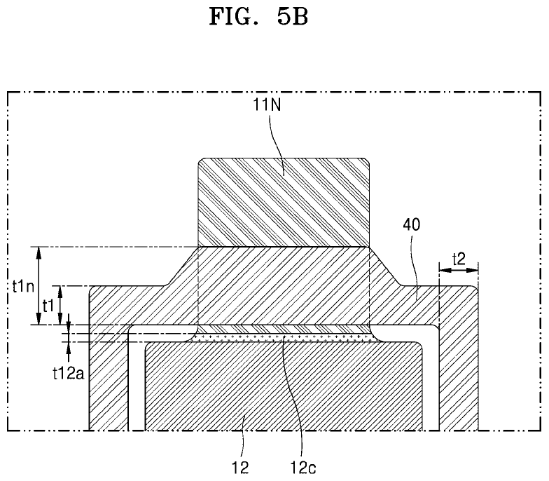

Further, as illustrated in FIG. 1, the all-solid secondary battery 1 may include a flame-retardant inactive member 40 disposed, e.g., directly, on and in, e.g., direct, contact with the solid electrolyte layer 30 and having a rectangular enclosure shape surrounding side surfaces of the cathode active material layer 12. For example, as illustrated in FIG. 1, the flame-retardant inactive member 40 may have a same thickness or a larger thickness than the cathode active material layer 12, and may, e.g., continuously, surround an entire perimeter of the cathode active material layer 12, e.g., in a frame shape, as viewed in a top view (FIG. 5A). For example, as further illustrated in FIG. 1, the flame-retardant inactive member 40 may be spaced apart from a lateral side of the cathode active material layer 12, e.g., along an entire perimeter of the cathode active material layer 12 (FIG. 5A).

Further, the all-solid secondary battery may have a C-type bi-cell structure. The C-type bi-cell structure is a structure in which two anode layers 20a, 20b are located on both sides of the cathode layer 10, and solid electrolyte layers 30a, 30b are located therebetween.

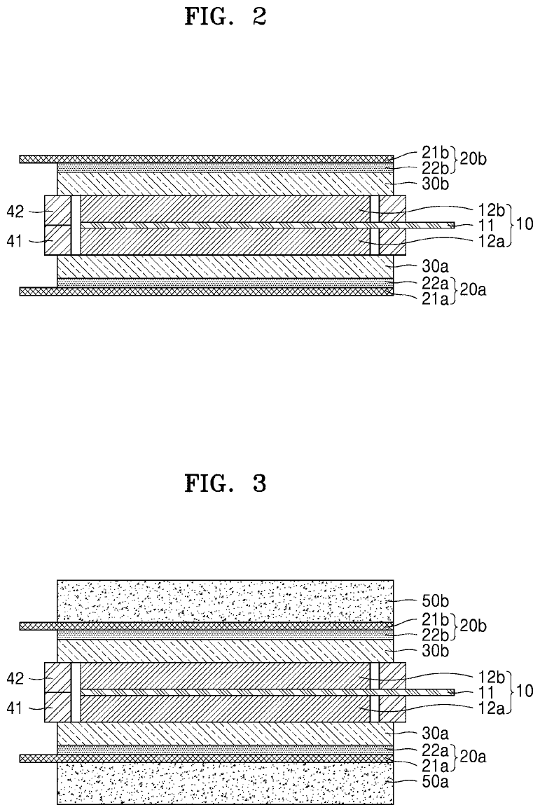

For example, as illustrated in FIG. 2, the all-solid secondary battery may include the cathode layer 10, the anode layers 20a, 20b, and the solid electrolyte layers 30a, 30b located therebetween. The cathode layer 10 may include the cathode current collector 11 and first and second cathode active material layers 12a and 12b on opposite surfaces, e.g., both sides, of the cathode current collector 11. The solid electrolyte layers 30a, 30b may include a first solid electrolyte layer 30a contiguous, e.g., in direct contact, with the first cathode active material layer 12a and a second solid electrolyte layer 30b contiguous, e.g., in direct contact, with the second cathode active material layer 12b. The anode layers 20a, 20b may include a first anode active material layer 22a and a second anode active material layer 22b, which are contiguous, e.g., in direct contact, with the first solid electrolyte layer 30a and the second solid electrolyte layer 30b, respectively, and may include a first anode current collector 21a and a second anode current collector 21b, which are contiguous, e.g., in direct contact, with the first anode active material layer 22a and the second anode active material layer 22b, respectively.

The flame-retardant inactive member may include a first flame-retardant inactive member 41 and a second flame-retardant inactive member 42, which are positioned to cover side, e.g., lateral, surfaces of the first cathode active material layer 12a and the second cathode active material layer 12b, respectively, between the first solid electrolyte layer 30a and the second solid electrolyte layer 30b. For example, the first and second flame-retardant inactive members 41 and 42 may directly contact each other, and may directly contact lateral surfaces of the first and second solid electrolyte layers 30a and 30b, respectively. For example, each of the first and second flame-retardant inactive members 40A and 40B in FIG. 2 may have a same structure as described above with reference to FIG. 1.

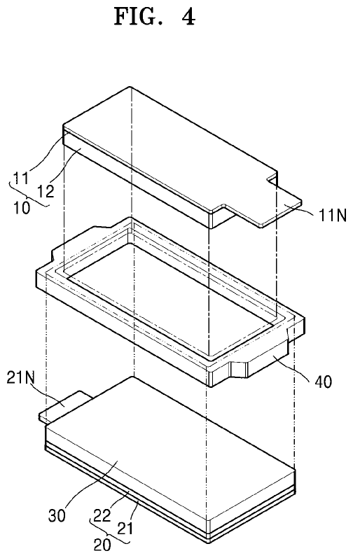

Referring to FIG. 3, the all-solid secondary battery may further include a first elastic sheet 50a and a second elastic sheet 50b, which are contiguous with the first anode current collector 21a and the second anode current collector 21b, respectively. For example, the first and second elastic sheets 50a and 50b may be on outermost surfaces of the first and second anode current collectors 21a and 21b, respectively.

Each constituent element will be described hereinbelow.

[Cathode Layer]

Referring to FIG. 1 to FIG. 3, the cathode layer 10 may include the cathode current collector 11 and the cathode active material layer 12 on one surface or opposing both surfaces of the cathode current collector 11. The flame-retardant inactive member 40 in a rectangular enclosure shape surrounds side surfaces of the cathode layer 10.

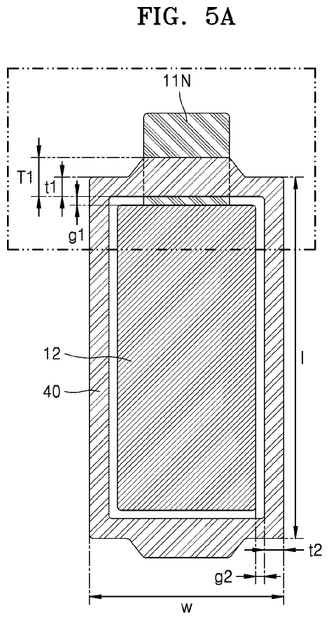

Here, as illustrated in FIG. 4 to FIG. 5B, the cathode current collector 11 may include a cathode uncoated portion composed of an exposed portion of the cathode current collector 11 without the cathode active material layer 12 disposed thereon. As illustrated in FIG. 5B, during the manufacture process of the cathode layer 10, punching a cathode plate after placing the cathode active material layer 12 on the cathode current collector 11 may cause a protrusion or an extension of the cathode active material layer 12 further toward a cathode uncoated portion 11N that would later connect to a terminal, to thereby form a protruded portion (e.g., an extended portion or an exposed portion 12c).

The exposed portion 12c of the cathode active material layer protruded onto the cathode uncoated portion 11N may have a smaller width (t12a), as illustrated in FIG. 5B. For example, the width (t12a) of the exposed portion 12c may be in a range of about 0 mm to about 1 mm, e.g., in a range of about 0 mm to about 0.5 mm. If the width (t12a) of the exposed portion 12c of the cathode active material layer 12 protruded onto the cathode uncoated portion 11N exceeds 1 mm, it would require the inner size of the flame-retardant inactive member 40 to be bigger than the size of the cathode layer 10 by greater than 1 mm, which may result in a decrease in the energy density of the all-solid secondary battery.

[Cathode Layer: Flame-Retardant Inactive Member]

As shown in FIGS. 1 to 7, The flame-retardant inactive member 40 may be disposed in contact with and on the solid electrolyte layer 30. The flame-retardant inactive member 40 may have a rectangular enclosure shape surrounding the side surfaces of the cathode layer 10.

Inclusion of the flame-retardant inactive member 40 serves to prevent cracking of the solid electrolyte layer 30 when manufacturing and/or during charging/discharging the all-solid secondary battery and, as a consequence, can improve cycle characteristics of the all-solid secondary battery. If an all-solid secondary battery does not include the flame-retardant inactive member 40, uneven pressure could be applied to the solid electrolyte layer 30 contiguous with a cathode layer 10 during the manufacture and/or charging/discharging of the all-solid secondary battery, thereby causing potential cracking in the solid electrolyte layer 30, which in turn, could cause short circuits.

In common lithium secondary batteries, an insulating tape of a thickness up to 30 μm may be attached to uncoated regions to prevent electric short circuits in cathode layers and anode layers. However, the use of an insulating tape may cause the taped area to be thicker by the thickness of the insulating tape, which may be a cause of uneven compression. In contrast, the all-solid secondary battery, according to example embodiments, may include the flame-retardant inactive member 40, thereby not requiring the use of such insulating tapes in the cathode layer 10 and the anode layer 20, thereby minimizing an overall thickness.

The flame-retardant inactive member 40 provided around the edge of the cathode layer 10 has the same rectangular enclosure shape as the cathode layer 10 excluding the cathode uncoated portion. Referring to FIG. 5A, the flame-retardant inactive member 40 may include a pair of first side portions and a pair of second side portions connected to the first side portions. If the first side portion corresponds to the shorter side of the rectangular enclosure shape and the second side portion corresponds to the longer side of the rectangular enclosure shape, the length 1 of the second side portion may be greater than a length w of the first side portion.

As further illustrated in FIG. 5A, gap (g1) between the first side portion of the flame-retardant inactive member 40 and the cathode active material layer 12 may be about 0 mm to about 1 mm, and gap (g2) between the second side portion of the flame-retardant inactive member 40 and the cathode active material layer 12 may be about 0 mm to about 0.5 mm. The gaps (g1, g2) between the flame-retardant inactive member 40 and the cathode active material layer 12 may be adjusted within the above ranges. If the gap (g1) between the first side portion of the flame-retardant inactive member 40 and the cathode active material layer 12 is greater than 1 mm, and/or the gap (g2) between the second side portion of the flame-retardant inactive member 40 and the cathode active material layer 12 is greater than 0.5 mm, during the pressing process, the areas of the solid electrolyte layer 30, where the flame-retardant inactive member 40 is not placed, may be less pressed or more pressed, leading to an increased likelihood of a short circuit during pressing or during charging.

The first side portion, e.g., the short side portion, of the flame-retardant inactive member 40 may include a protruding portion corresponding to the cathode uncoated portion 11N or an anode uncoated portion 21N. The protruding portion of the first side portion of the flame-retardant inactive member 40 may be disposed on, e.g., overlap, the cathode uncoated portion 11N. The protruding portion of the first side portion of the flame-retardant inactive member 40 may be disposed on the anode uncoated portion 21N. A width (T1) of the protruding portion of the first side portion may be greater than a width (t1) of the remaining portion of the first side portion, e.g., a maximal total width (T1) of the protruding portion of the first side portion may be greater than a width (t1) of a portion of the flame-retardant in active member 40 adjacent to the protruding portion.

The protruding portion of the first side portion may play a role in preventing short circuits of the cathode layer and the anode layer, and preventing a failure or separation of the cathode uncoated portion 11N and the anode uncoated portion 21N by pressing. For this reason, the width (T1) of the protruding portion of the first side portion may be adjusted to be greater than the width (t1) of the remaining portion of the first side portion.

If the flame-retardant inactive member 40 were to be made to have a uniform width, i.e., T1=t1==t2, it could have lessened processing difficulty. However, in such a structure, if the cathode active material layer were further protruded toward the cathode uncoated portion 11N to form the exposed portion 12c, the relevant area would have been thicker, thereby potentially leading to breakage of the flame-retardant inactive member 40.

The width (T1) of the protruding portion of the first side portion may be in a range of about 1 mm to about 4.5 mm. Within this range, an all-solid secondary battery with high energy density can be provided without causing difficulty in tab welding.

In the flame-retardant inactive member 40, width (t2) of the second side portion may be smaller than the width (T1) of the protruding portion of the first side portion and may be equal to or smaller than the width (t1) of the remaining portion of the first side portion. The width (t1) of the remaining portion of the first side portion may be equal to the width (t2) of the second side portion.

For example, the width (t1) of the remaining portion of the first side portion may be about 0.5 mm to about 4 mm, and the width (t2) of the second side portion may be about 0.5 mm to about 3 mm. If (t1) and (t2) are less than 0.5 mm, the stacking process of the member may become difficult or impossible, and the cathode layer and the anode layer may become extremely prone to short circuits. If (t1) is greater than 4 mm and/or (t2) is greater than 3 mm, it may decrease the energy density of the all-solid secondary battery.

According to one embodiment, the first side portion and second side portion of the flame-retardant inactive member 40 may be integrally formed. According to another embodiment, the first side portion and second side portion of the flame-retardant inactive member 40 may be separately prepared, followed by assembly of the first and second side portions to form a rectangular enclosure shape. The rectangular enclosure shape may include a rectangular gasket shape. The flame-retardant inactive member 40 may be a gasket.

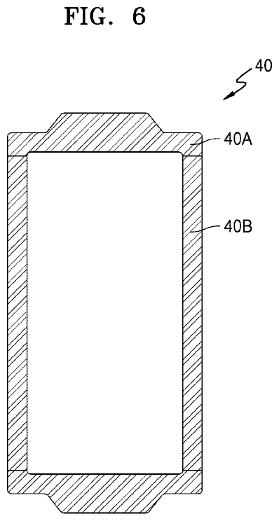

As shown in FIG. 6, the flame-retardant inactive member 40 may be a segmented member including, e.g., consisting of, a first side portion 40A and a second side portion 40B, which are separately prepared and later assembled, e.g., coupled to each other. For example, the first side portion 40A of the segmented member may be short and bent at both ends thereof, configured so as to include corner portions of the rectangular enclosure shape at both ends thereof, and may be placed on the side of a terminal portion. For example, the second side portion 40B of the segmented member may be in a rectangular shape and placed on a side that is not the side of the terminal portion.

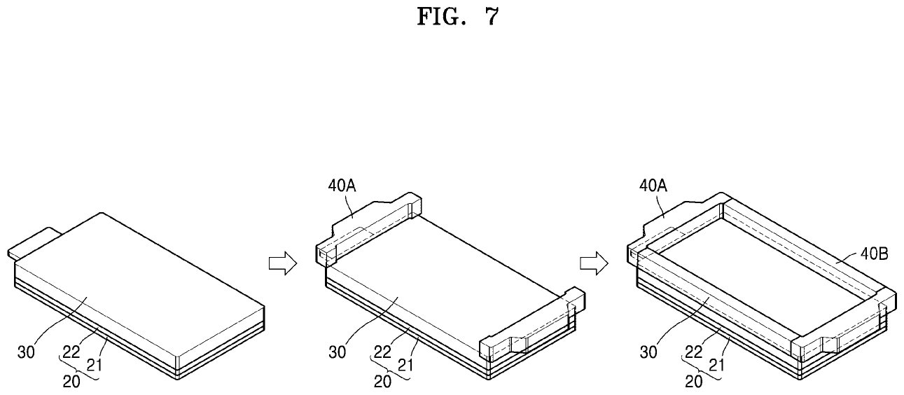

The first side portion 40A and the second side portion 40B of the segmented member may be produced by a roll process and notching, respectively. As shown in FIG. 7, the segmented member thus produced may be assembled to form the flame-retardant inactive member 40 in a rectangular enclosure shape by first placing the first side portion 40A and then placing the second side portion 40B on an anode layer with a solid electrolyte layer transferred thereon.

To allow the flame-retardant inactive member 40 to be stably placed on the solid electrolyte layer 30, the size of the solid electrolyte layer 30 may be smaller than the outer size of the flame-retardant inactive member 40 and greater than the inner size of the flame-retardant inactive member 40. For example, the size of the solid electrolyte layer 30 may occupy 50% or more of each of the first side portion and the second side portion of the flame-retardant inactive member 40.

The flame-retardant inactive member 40 may be contiguous with the solid electrolyte layer 30 while surrounding the side surfaces of the cathode layer 10. Since the flame-retardant inactive member 40 is contiguous with the solid electrolyte layer 30 while surrounding the side surfaces of the cathode layer 10, in the solid electrolyte layer 30 that is not contiguous with the cathode layer 10, cracking of the solid electrolyte layer 30 caused by a pressure difference during the press process may be effectively prevented. The flame-retardant inactive member 40, while surrounding the side surfaces of the cathode layer 10, is separated from the anode layer 20, in particular from an anode active material layer 22. Accordingly, the likelihood of a short circuit due to physical disconnection between the cathode layer 10 and the anode active material layer 22, or the likelihood of a short circuit due to overcharging of lithium, etc. may be substantially reduced.

The flame-retardant inactive member 40 may include a matrix and a filler.

For example, the matrix may include a substrate and a reinforcement material. Inclusion of the substrate in the matrix may impart elasticity to the matrix. Accordingly, the matrix may be located at varying positions while effectively accommodating volume changes of the all-solid secondary battery during charging and discharging.

The substrate included in the base may include a first fibrous material. Inclusion of the first fibrous material in the substrate enables effective accommodation of volume changes of the solid electrolyte layer 30 that occur during charging and discharging, and effective suppression of deformations of the flame-retardant inactive member 40 that may result from such volume changes of the solid electrolyte layer 30. For example, the first fibrous material may be a material having an aspect ratio of 5 or more, 20 or more, or 50 or more. For example, the first fibrous material may be a material having an aspect ratio of about 5 to about 1,000, about 20 to about 1,000, or about 50 to about 1,000.

For example, the first fibrous material may be an insulating material. Due to the first fibrous material being an insulating material, short circuits between the solid electrolyte layer 30 and the anode layer 20 that may occur during charging/discharging from lithium dendrites or the like may be effectively prevented.

Examples of the first fibrous material may include one or more of pulp fibers, insulating polymer fibers, and ion conductive polymer fibers. Examples of the pulp fibers may include cellulose fibers. The cellulose fibers may be cellulose microfibers or cellulose nanofibers. Examples of the insulating polymer fibers may include polyimide fibers, polyaramid fibers, polyethylene fibers, polyphenylene sulfide fibers, and the like. Examples of the ionic polymer fibers may include polystyrene sulfonate (PSS) fibers, polyvinylidene fluoride-hexafluoropropylene (PVDF-HFP) fibers polyvinyl fluoride (PVF) fibers, polyvinylidene fluoride (PVDF) fibers, and the like.

Inclusion of the reinforcing material in the matrix may enhance strength of the matrix. Accordingly, the matrix may prevent the all-solid secondary battery from undergoing excessive volume changes during charging/discharging and prevent deformation of the all-solid secondary battery.

For example, the substrate included in the base may include a second fibrous material. Inclusion of the second fibrous material in the reinforcing material enables a more uniform increase of the strength of the matrix. For example, the second fibrous material may be a material having an aspect ratio of 3 or more, 5 or more, or 10 or more. For example, the first fibrous material may be a material having an aspect ratio of about 3 to about 100, about 5 to about 100, or about 10 to about 100.

For example, the second fibrous material may be a flame-retardant material. Due to the second fibrous material being a flame-retardant material, combustion from thermal runaways that occur during charging/discharging process of the all-solid secondary battery or caused by an external impact can be effectively suppressed. Examples of the second fibrous material may include glass fiber, metal oxide fibers, ceramic fibers, and the like. Examples of the metal oxide fibers may include silica (SiO₂) fibers, alumina (Al₂O₃) fibers, (bohemite) fibers, and the like. Examples of the ceramic fibers may include silicon carbide (SiC) fibers and the like.

The flame-retardant inactive member 40 may include a matrix and a filler. The filler may be inside the matrix, may be on the surface of the matrix, or may be both inside and on the surface of the matrix. Examples of the filler may include an inorganic material.

The filler included in the flame-retardant inactive member 40 may be, e.g., a moisture getter. For example, the filler may absorb moisture at a temperature of less than 100° C., thereby removing residual moisture in the all-solid secondary battery, and thus may prevent degradation of the all-solid secondary battery. Further, the filler may release the absorbed moisture to thereby effectively prevent combustion of the all-solid secondary battery if the temperature of the all-solid secondary battery increases to 150° C. or higher due to thermal runaway caused during charging/discharging process of the all-solid secondary battery or caused by external impact. For example, the filer may be a flame-retardant. For example, the filler may be a metal hydroxide having hygroscopic properties. Examples of the metal hydroxide included in the filler may include Mg(OH)₂, Fe(OH)₃, Sb(OH)₃, Sn(OH)₄, TI(OH)₃, Zr(OH)₄, Al(OH)₃, or a combination thereof.

For example, the flame-retardant inactive member 40 may include a binder. The binder may include a curable polymer for example. The curable polymer may be a polymer that gets cured by heat and/or pressure. For example, the curable polymer may be solid at room temperature. Examples of the flame-retardant inactive member 40 may include a heat-press curable film and/or a cured product thereof. For example, the heat-press curable film may be TSA-66 by Toray. In addition, the binder may include a regular binder used in the art. Examples of the binder include fluorine-based binders, e.g., polyvinylidene fluoride, and acryl-based binders, e.g., polyacrylates.

The flame-retardant inactive member 40 may further include other materials in addition to the substrate, reinforcing material, filler, and binder described above. The flame-retardant inactive member 40 may further include, e.g., one or more selected from among paper, insulating polymers, ion conductive polymers, insulating inorganic materials, oxide-based solid electrolytes, and sulfide-based solid electrolytes. Examples of the insulating polymers include olefin-based polymers, e.g., polypropylene (PP), polyethylene (PE), and the like.

The density of the substrate or the reinforcing material included in the flame-retardant inactive member 40 may be, e.g., about 10% to about 300%, about 10% to about 150%, about 10% to about 140%, about 10% to about 130%, or about 10% to about 120%, relative to the density of the cathode active material included in the cathode active material layer 12.

The density of the substrate may be, e.g., about 10% to about 300%, about 10% to about 150%, about 10% to about 140%, about 10% to about 130%, or about 10% to about 120%, relative to the density of cathode active material included in the cathode active material layer 12. The density of the substrate may be, e.g., about 50% to about 200% relative to the density of the cathode active material included in the cathode active material layer 12. The density of the reinforcing material may be, e.g., about 50% to about 300%, about 50% to about 150%, about 50% to about 140%, about 50% to about 130%, or about 50% to about 120%, relative to the density of solid electrolyte included in the solid electrolyte layer 30. The density of the reinforcing material may be, e.g., about 50% to about 200% relative to the density of the solid electrolyte included in the solid electrolyte layer 30.

The flame-retardant inactive member 40 is a member that does not contain any material with electrochemical activity, i.e., electrode active materials. The electrode active material is a material absorbing/desorbing lithium. The flame-retardant inactive member 40 is a member composed of a material other than electrode active materials.

[Cathode Layer: Cathode Active Material]

The cathode active material layer 12 may include, e.g., a cathode active material and a solid electrolyte. The solid electrolyte included in the cathode layer 10 may be similar to or different from the solid electrolyte included in the solid electrolyte layer 30. Details on the solid electrolyte can be found in the description of the solid electrolyte layer 30.

The cathode active material is a cathode active material capable of reversible absorption/desorption of lithium ions. Examples of the cathode active material may include a lithium transition metal oxide, e.g., lithium cobalt oxide (LCO), lithium nickel oxide, lithium nickel cobalt oxide, lithium nickel cobalt aluminum oxide (NCA), lithium nickel cobalt manganese oxide (NCM), lithium manganate, and lithium ion phosphate; and nickel sulfide, copper sulfide, lithium sulfide, iron oxide, vanadium oxide, or the like. The cathode active material may be a single material or a mixture of two or more materials.

The lithium transition metal oxide may be, e.g., a compound represented by any one of the following formulas: LiₐA_{1-b}B_{b}D₂ (In the formula, 0.90≤a≤1 and 0≤b≤0.5); LiₐE_{1-b}B_{b}O_{2-c}D_{c} (In the formula, 0.90≤a≤1, 0≤b≤0.5, 0≤c≤0.05); LiE_{2-b}B_{b}O_{4-c}D_{c} (In the formula, 0≤b≤0.5, 0≤c≤0.05); LiₐNi_{1-b-c}Co_{b}B_{c}D_{α} (In the formula, 0.90≤a≤1, 0≤b≤0.5, 0≤c≤0.05, 0<α≤2); LiₐNi_{1-b-c}Co_{b}B_{c}O_{2-α}F₂ (In the formula, 0.90≤a≤1, 0≤b≤0.5, 0≤c≤0.05, 0<α≤2); LiₐNi_{1-b-c}Co_{b}B_{c}O_{2-α}F₂ (In the formula, 0.90≤a≤1, 0≤b≤0.5, 0≤c≤0.05, 0<α<2); LiₐNi_{1-b-c}Mn_{b}B_{c}D_{α} (In the formula, 0.90≤a≤1, 0≤b≤0.5, 0≤c≤0.05, 0<α≤2); LiₐNi_{1-b-c}Mn_{b}B_{c}O_{2-α}F_{α} (In the formula, 0.90≤a≤1, 0≤b≤0.5, 0≤c≤0.05, 0<α<2); LiₐNi_{1-b-c}Mn_{b}B_{c}O_{2-α}F_{α} (In the formula, 0.90≤a≤1, 0≤b≤0.5, 0≤c≤0.05, 0<α<2); LiₐNi_{b}E_{c}G_{d}O₂ (In the formula, 0.90≤a≤1, 0≤b≤0.9, 0≤c≤0.5, 0.001≤d≤0.1); LiₐNi_{b}Co_{c}Mn_{d}GeO₂ (In the formula, 0.90≤a≤1, 0≤b≤0.9, 0≤c≤0.5, 0≤d≤0.5, 0.001≤e≤0.1); LiₐNiG_{b}O₂ (In the formula, 0.90≤a≤1, 0.001≤b≤0.1); LiₐCoG_{b}O₂ (In the formula, 0.90≤a≤1, 0.001≤b≤0.1); LiₐMnG_{b}O₂ (In the formula, 0.90≤a≤1, 0.001≤b≤0.1); LiₐMn₂G_{b}O₄ (In the formula, 0.90≤a≤1, 0.001≤b≤0.1); QO₂; QS₂; LiQS₂; V₂O₅; LiV₂O₅; LiIO₂; LiNiVO₄; Li_{(3-f)}J₂(PO₄)₃ (0≤f≤2); Li_{(3-f)}Fe₂(PO₄)₃(0≤f≤2); and LiFePO₄. In such a compound, A is Ni, Co, Mn, or a combination thereof; B is Al, Ni, Co, Mn, Cr, Fe, Mg, Sr, V, a rare-earth element, or a combination thereof; D is O, F, S, P, or a combination thereof; E is Co, Mn, or a combination thereof; F is F, S, P, or a combination thereof; G is Al, Cr, Mn, Fe, Mg, La, Ce, Sr, V, or a combination thereof; Q is Ti, Mo, Mn, or a combination thereof; I is Cr, V, Fe, Sc, Y, or a combination thereof; and J is V, Cr, Mn, Co, Ni, Cu, or a combination thereof.

A compound having a coating layer added on a surface of the above compound may also be used, and a mixture of the above compound and a compound having a coating layer added thereon may also be used. For example, the coating layer added on the surface of the above compound may include compounds of a coating element, e.g., oxides and hydroxides of the coating element, oxyhydroxides of the coating element, oxycarbonates of the coating element, and hydroxycarbonates of the coating element. Compounds forming the above coating layer may be amorphous or crystalline. The coating element included in the coating layer may be Mg, Al, Co, K, Na, Ca, Si, Ti, V, Sn, Ge, Ga, B, As, Zr, or a mixture thereof. The method by which the coating layer is formed, is selected from among methods that do not adversely affect the physical properties of a cathode active material. Examples of the coating method include spray coating, dip coating, and the like.

The cathode active material may include among the aforementioned lithium transition metal oxides, e.g., a lithium salt of a transition metal oxide that has a layered rock-salt type structure. The “layered rock salt type structure” is, e.g., a structure where an oxygen atom layer and a metal atom layer are alternatingly regularly arranged in <111> direction of a cubic rock salt type structure, and as a result, each atom layer forms a two-dimensional plane. The “cubic rock salt type” represents a NaCl type structure, which is a type of lattice structure, and specifically represents a structure in which the face centered cubic lattices (fcc) formed by each cation and anion are positioned obliquely by ½ of the ridge of unit lattice. Examples of the lithium transition metal oxide having such a layered rock-salt type structure may be a ternary lithium transition metal oxide, e.g., LiNiₓCo_{y}Al_{z}O₂ (NCA) or LiNiₓCo_{y}Mn_{z}O₂ (NCM) (0<x<1, 0<y<1, 0<z<1, and x+y+z=1). When the cathode active material contains a ternary lithium transition metal oxide having a layered rock-salt type structure, energy density and thermal stability of the all-solid secondary battery may be further improved.

The cathode active material may be covered by a coating layer, as described above. The coating layer may be any material known as a coating layer of cathode active material in all-solid secondary batteries. The coating layer may include, e.g., Li₂O—ZrO₂ (LZO).

In addition, when the cathode active material contains nickel (Ni) by being formed of a lithium salt of a ternary transition metal oxide, e.g., NCA or NCM, a capacity density of the all-solid secondary battery may increase, and thus metal elution from the cathode active material in a charged state may be reduced. Thus, the all-solid secondary battery may have improved cycle characteristics in a charged state.

For example, a shape of the cathode active material may be a particle shape, e.g., a true spherical shape or an elliptical spherical shape. In addition, a particle diameter of the cathode active material is not particularly limited but may be in a range applicable to a cathode active material of a conventional all-solid secondary battery. In addition, an amount of the cathode active material contained in the cathode layer 10 is not particularly limited but may be in a range applicable to a cathode layer of a conventional all-solid secondary battery.

[Cathode Layer: Solid Electrolyte]

The cathode active material layer 12 may include, e.g., a solid electrolyte. The solid electrolyte included in the cathode layer 10 may be similar to or different from a solid electrolyte included in the solid electrolyte layer 30. Details regarding the solid electrolyte can be found in the description of the solid electrolyte layer 30.

The solid electrolyte included in the cathode active material layer 12 may have a smaller median particle diameter D50 than that of the solid electrolyte included in the solid electrolyte layer 30. For example, the median particle diameter D50 of the solid electrolyte included in the cathode active material layer 12 may be 90% or less, 80% or less, 70% or less, 60% or less, 50% or less, 40% or less, 30% or less, or 20% or less, relative to the median particle diameter D50 of the solid electrolyte included in the solid electrolyte layer 30.

The median particle diameter D50 is, e.g., a median particle diameter (D50). Median particle diameter (D50) refers to a particle size corresponding to a cumulative volume of 50 vol % in a particle size distribution as measured by laser diffraction method when counting from the smallest particle size.

[Cathode Layer: Binder]

For example, the cathode active material layer 12 may include a binder. The binder may be, e.g., styrene butadiene rubber (SBR), polytetrafluoroethylene, polyvinylidene fluoride, polyethylene, and the like.

[Cathode Layer: Conductive Material]

For example, the cathode active material layer 12 may include a conductive material. The conductive material may be, e.g., graphite, carbon black, acetylene black, Ketjen black, carbon fibers, metal powder, and the like.

[Cathode Layer: Other Additives]

For example, the cathode active material layer 12 may further include additives, e.g., a filler, a coating agent, a dispersing agent, and an ion-conducting agent, in addition to the cathode active material, solid electrolyte, binder, and conductive material described above. For the filler, coating agent, dispersing agent, and ion-conducting agent that may be included in the cathode active material layer 12, any suitable material may be used.

[Cathode Layer: Cathode Current Collector]

The cathode current collector 11 may utilize, e.g., indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or a plate or foil made of an alloy thereof, or the like. The cathode current collector 11 may be omitted. A thickness of the cathode current collector 11 may be, e.g., from about 1 μm to about 100 μm, about 1 μm to about 50 μm, about 5 μm to about 25 μm, or about 10 μm to about 20 μm.

[Solid Electrolyte Layer]

[Solid Electrolyte Layer: Solid Electrolyte]

Referring to FIGS. 1 to 4, the solid electrolyte layer 30 may include a solid electrolyte positioned between the cathode layer 10 and the anode layer 20. The solid electrolyte may be, e.g., a sulfide-based solid electrolyte.

The sulfide-based solid electrolyte may be, e.g., one or more selected from among Li₂S—P₂S₅ and Li₂S—P₂S₅—LiX, wherein X is a halogen element; Li₂S—P₂S₅—Li₂O, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—B₂S₃, and Li₂S—P₂S₅—ZmSn, wherein m and n are positive numbers, and Z is Ge, Zn or Ga; Li₂S—GeS₂, Li₂S—SiS₂—Li₃PO₄, and Li₂S—SiS₂—LiₚMO_{q}, wherein p and q are positive numbers and M is P, Si, Ge, B, Al, Ga or In; Li₇₋ₓPS₆₋ₓClₓ, wherein 0≤x≤2; Li₇₋ₓPS₆₋ₓBrₓ, wherein 0≤x≤2; and Li₇₋ₓPS₆₋ₓBrₓ, wherein 0≤x≤2. The sulfide-based solid electrolyte may be prepared by treatment of starting materials, e.g., Li₂S and P₂S₅, by melt-quenching, mechanical milling, and the like. In addition, following such treatment, sintering may be conducted. The solid electrolyte may be amorphous or crystalline or may be in a mixed state thereof. For example, among the sulfide-based solid electrolyte materials described herein, a material containing at least sulfur (S), phosphorus (P), and lithium (Li), may be used as the solid electrolyte. For example, the solid electrolyte may be a material containing Li₂S—P₂S₅.leexampel, when the solid electrolyte including Li₂S—P₂S₅ as the sulfide-based solid electrolyte material is used, a mixing molar ratio of Li₂S and P₂S₅ may be in a range of Li₂S:P₂S₅=about 50:50 to about 90:10.

The sulfide-based solid electrolyte may include, e.g., an argyrodite type solid electrolyte represented by Formula 1:

Li⁺₁₂₋ₙ₋ₓAⁿ⁺X²⁻₆₋ₓY⁻ₓ <Formula 1>

In Formula 1, A is P, As, Ge, Ga, Sb, Si, Sn, Al, In, Ti, V, Nb or Ta; X is S, Se or Te; Y is Cl, Br, I, F, CN, OCN, SCN, or N₃; and 1≤n≤5 and 0≤x≤2. The sulfide-based solid electrolyte may be an argyrodite-type compound including one or more of Li₇₋ₓPS₆₋ₓClₓ, wherein 0≤x≤2, Li₇₋ₓPS₆₋ₓBrₓ, wherein 0≤x≤2, and Li₇₋ₓPS₆₋ₓIₓ, wherein 0≤x≤2. The sulfide-based solid electrolyte may be an argyrodite-type compound including one or more of Li₆PS₅Cl, Li₆PS₅Br, and Li₆PS₅I.

The density of the argyrodite-type solid electrolyte may be about 1.5 g/cc to about 2.0 g/cc. Internal resistance of the all-solid secondary battery may be reduced and Li penetration into the solid electrolyte layer may be more effectively suppressed by having the density of the argyrodite-type solid electrolyte being 1.5 g/cc or more.

[Solid Electrolyte Layer: Binder]

For example, the solid electrolyte layer 30 may include a binder. The binder included in the solid electrolyte layer 30 may be, e.g., styrene butadiene rubber (SBR), polytetrafluoroethylene, polyvinylidene fluoride, polyethylene, and the like. The binder in the solid electrolyte layer 30 may be identical to or different from a binder included in the cathode active material layer 12 and the anode active material layer 22. The binder may be omitted. The content of the binder included in the solid electrolyte layer 30 may be, e.g., about 0 wt % to about 10 wt %, about 0 wt % to about 5 wt %, about 0 wt % to about 3 wt %, about 0 wt % to about 1 wt %, about 0 wt % to about 0.5 wt %, or about 0 wt % to about 0.1 wt %, relative to the total weight of the solid electrolyte layer 30.

[Anode Layer]

[Anode Layer: Anode Active Material]

The anode active material layer 22 may include, e.g., an anode active material and a binder.

The anode active material included in the anode active material layer 22 may have, e.g., a particle shape. The median particle diameter of the anode active material having a particle shape may be, e.g., 4 μm or less, 3 μm or less, 2 μm or less, 1 μm or less, or 900 nm or less. The median particle diameter of the anode active material having a particle shape may be, e.g., from about 10 nm to about 4 from about 10 nm to about 3 from about 10 nm to about 2 from about 10 nm to about 1 or from about 10 nm to about 900 nm. By having the median particle diameter of the anode active material being in such ranges, reversible absorbing and/or desorbing of lithium may take place more easily during charging/discharging. The median particle diameter of the anode active material may be, e.g., a median particle diameter (D50) as measured using a laser-type particle size distribution analyzer.

The anode active material included in the anode active material layer 22 may include, e.g., one or more selected from among a carbonaceous anode active material and a metal or metalloid anode active material.

The carbonaceous anode active material may be in particular, an amorphous carbon. The amorphous carbon may be, e.g., carbon black (CB), acetylene black (AB), furnace black (FB), Ketjen black (KB), graphene, or the like. Amorphous carbon is carbon without crystallinity or with an extremely low degree of crystallinity, and as such is distinguished from crystalline carbon or graphitic carbon.

The metal or metalloid anode active material may include one or more of gold (Au), platinum (Pt), palladium (Pd), silicon (Si), silver (Ag), aluminum (Al), bismuth (Bi), tin (Sn), and zinc (Zn), and may be any metal anode active material or metalloid anode active material in the art that is capable of forming an alloy or a compound with lithium. For example, nickel (Ni) does not form an alloy with lithium and therefore is not a metal anode active material.

The anode active material layer 22 may include one or more of such anode active materials, or may include a mixture of multiple different anode active materials. For example, the anode active material layer 22 may include only amorphous carbon as the anode active material, or may include at least one of gold (Au), platinum (Pt), palladium (Pd), silicon (Si), silver (Ag), aluminum (Al), bismuth (Bi), tin (Sn), and zinc (Zn). In addition, the anode active material layer 22 may include a mixture of amorphous carbon and at least one of gold (Au), platinum (Pt), palladium (Pd), silicon (Si), silver (Ag), aluminum (Al), bismuth (Bi), tin (Sn), and zinc (Zn). A mixing ratio, in terms of weight, of the mixture of amorphous carbon to the metal(s) described herein, e.g., gold (Au), may be about 10:1 to about 1:2, about 5:1 to about 1:1, or about 4:1 to about 2:1. By having the anode active material having such a composition, cycle characteristics of the all-solid secondary battery may be further improved.

The anode active material included in the anode active material layer 22 may include, e.g., a mixture of first particles composed of amorphous carbon, and second particles composed of a metal or a metalloid. Examples of the metal or the metalloid include gold (Au), platinum (Pt), palladium (Pd), silicon (Si), silver (Ag), aluminum (Al), bismuth (Bi), tin (Sn), zinc (Zn), and the like. In addition, the metalloid may be a semiconductor. The content of the second particles may be about 8 wt % to about 60 wt %, about 10 wt % to about 50 wt %, about 15 wt % to about 40 wt %, or about 20 wt % to about 30 wt %, relative to the total weight of the mixture. By having the content of the second particles in such ranges, cycle characteristics of the all-solid secondary battery 1 may further improve.

[Anode Layer: Binder]

The binder included in the anode active material layer 22 may be, e.g., styrene butadiene rubber (SBR), polytetrafluoroethylene, polyvinylidene fluoride, polyethylene, a vinylidene fluoride/hexafluoropropylene copolymer, polyacrylonitrile, polymethylmethacrylate, or the like. The binder may include only one, or two or more of the foregoing binder materials.

By having the anode active material layer 22 having a binder, the anode active material layer 22 may be stabilized on the anode current collector 21. In addition, despite volume changes and/or relative position changes of the anode active material layer 22 during charging/discharging, cracking of the anode active material layer 22 may be suppressed. For example, if the anode active material layer 22 does not contain any binder, the anode active material layer 22 may easily separate from the anode current collector 21. The likelihood of a short circuit may be increased as the anode current collector 21 comes in contact with the solid electrolyte layer 30 at an exposed part of the anode current collector 21 formed as the anode current collector 21 has separated from the anode current collector 21. The anode active material layer 22 may be prepared by coating a slurry having materials constituting the anode active material layer 22 dispersed therein onto the anode current collector 21, followed by drying. By including a binder in the anode active material layer 22, stable dispersion of anode active materials within the slurry may be achieved. For example, when coating the slurry onto the anode current collector 21 by a screen printing method, clogging of a screen (e.g., clogging by aggregates of anode active material) can be suppressed.

[Anode Layer: Other Additives]

The anode active material layer 22 may further include at least one additive e.g., a filler, a coating agent, a dispersing agent, an ion-conducting agent, or the like.

[Anode Layer: Anode Active Material Layer]

A thickness of the anode active material layer 22 may be, e.g., 50% or less, 40% or less, 30% or less, 20% or less, 10% or less, or 5% or less, relative to a thickness of the cathode active material layer 12. A thickness of the anode active material layer 22 may be, e.g., from about 1 μm to about 20 μm, about 2 μm to about 10 μm, or about 3 μm to about 7 μm. When the anode active material layer 22 has an excessively small thickness, lithium dendrites formed between the anode active material layer 22 and the anode current collector 21 may disintegrate the anode active material layer 22, thus making it difficult to improve cycle characteristics of the all-solid secondary battery. When the anode active material layer 22 has an excessively large thickness, energy density of the all-solid secondary battery may be decreased and internal resistance of the all-solid secondary battery by the anode active material layer 22 may be increased, thus making it difficult to improve cycle characteristics of the all-solid secondary battery.

As the thickness of the anode active material layer 22 is decreased, e.g., the charging capacity of the anode active material layer 22 is also decreased. The charging capacity of the anode active material layer 22 may be, e.g., 50% or less, 40% or less, 30% or less, 20% or less, 10% or less, 5% or less, or 2% or less, relative to the charging capacity of the cathode active material layer 12. The charging capacity of the anode active material layer 22 may be, e.g., about 0.1% to about 50%, about 0.1% to about 40%, about 0.1% to about 30%, about 0.1% to about 20%, about 0.1% to about 10%, about 0.1% to about 5%, or about 0.1% to about 2%, relative to the charging capacity of the cathode active material layer 12. When the anode active material layer 22 has an excessively small charging capacity, the thickness of the anode active material layer 22 becomes extremely small, and therefore, during repeated charging/discharging processes, lithium dendrites formed between the anode active material layer 22 and the anode current collector 21 may disintegrate the anode active material layer 22 and thus make it difficult to improve cycle characteristics of the all-solid secondary battery. When the anode active material layer 22 has an excessively large charging capacity, energy density of the all-solid secondary battery may be decreased and internal resistance of the all-solid secondary battery by the anode active material layer 22 may be increased, thus making it difficult to improve cycle characteristics of the all-solid secondary battery.

Here, the charging capacity of the cathode active material layer 12 may be obtained by multiplying the charging capacity density (mAh/g) of the cathode active material by the mass of the cathode active material in the cathode active material layer 12. When a plurality of cathode active materials are used, the multiplication value of the charging capacity density and the mass of each of the cathode active materials is calculated, and the sum of the multiplication values may be defined as the charging capacity of the cathode active material layer 12. The charging capacity of the anode active material layer 22 is obtained by the same method as described herein with respect to the cathode active material layer 12. Here, the charging capacity of the anode active material layer 22 may be obtained by multiplying the charging capacity density (mAh/g) of the anode active material by the mass of the anode active material in the anode active material layer 22. When a plurality of anode active materials are used, the multiplication value of the charging capacity density and the mass of each of the multiple anode active materials is calculated, and the sum of the multiplication values may be defined as the charging capacity of the anode active material layer 22. Here, the charging capacity densities of the cathode and anode active materials are capacities estimated using all-solid half cells using a lithium metal as a counter electrode. The charging capacities of the cathode active material layer 12 and the anode active material layer 22 may be directly measured with the all-solid half cells. The charging capacity thus measured is divided by the mass of each active material, thereby obtaining the charging capacity density. In addition, the charging capacity of the cathode active material layer 12 and the anode active material layer 22 may be an initial charging capacity measured at the time of first cycle charging.

### [Anode Layer: Metal Layer (Second Anode Active Material Layer)]

Although not illustrated in the drawings, the all-solid secondary battery may further include, e.g., a second anode active material layer formed between the anode current collector 21 and the anode active material layer 22 by charging. The second anode active material layer may be a metal layer including lithium or a lithium alloy. The metal layer may include lithium or a lithium alloy. The metal layer including lithium may act as a lithium reservoir, for example. The lithium alloy may include, for example, Li—Al alloy, Li—Sn alloy, Li—In alloy, Li—Ag alloy, Li—Au alloy, Li—Zn alloy, Li—Ge alloy, Li—Si alloy, and the like. The metal layer may be composed of one of such alloys or lithium, or may be composed of various types of alloys. The metal layer may be, e.g., a plated layer. The metal layer may be, e.g., precipitated between the anode active material layer 22 and the anode current collector 21 during the charging process of the all-solid secondary battery.

For example, a thickness of the metal layer may be about 1 μm to about 1,000 μm, about 1 μm to about 500 μm, about 1 μm to about 200 μm, about 1 μm to about 150 μm, about 1 μm to about 100 μm, or about 1 μm to about 50 μm. If the thickness of the metal layer is too small, it may be difficult for the metal layer to act as a lithium reservoir. If the thickness of the metal layer is too large, the mass and volume of the all-solid secondary battery may be increased, and cycle characteristics thereof may be rather decreased. The metal layer may be, e.g., a metal foil having a thickness in such ranges.

In the all-solid secondary battery, the metal layer may be positioned, for example, between the anode current collector 21 and the anode active material layer 22 prior to assembly of the all-solid secondary battery, or may be precipitated between the anode current collector 21 and the anode active material layer 22 by charging after assembly of the all-solid secondary battery. When a metal layer including lithium is positioned between the anode current collector 21 and the anode active material layer 22 as a second anode active material layer prior to assembly of the all-solid secondary battery, the metal layer may act as a lithium reservoir. For example, prior to assembly of the all-solid secondary battery, a lithium foil may be positioned between the anode current collector 21 and the anode active material layer 22. By having such an arrangement, cycle characteristics of the all-solid secondary battery including the metal layer may be further improved.

In case of the metal layer being precipitated by charging after assembly of the all-solid secondary battery, since the all-solid secondary battery at the time of assembly does not contain a metal layer, energy density of the all-solid secondary battery may be increased. For example, when charging the all-solid secondary battery, the all-solid secondary battery is charged so as to exceed the charging capacity of the anode active material layer 22. That is, the anode active material layer 22 is overcharged. At an initial charging stage, lithium is absorbed into the anode active material layer 22. That is, the anode active material included in the anode active material layer 22 forms an alloy or compound with lithium ions migrated from the cathode layer 10. If charging is performed exceeding the capacity of the anode active material layer 22, lithium is precipitated, for example, on the back of the anode active material layer 22, that is, between the anode current collector 21 and the anode active material layer 22, and a metal layer that corresponds to a second anode active material layer is formed by the precipitated lithium. This result is obtained by forming the anode active material included in the anode active material layer 22 using a material that forms an alloy or compound with lithium. During discharge, lithium in the anode active material layer 22 and the metal layer may be ionized to then migrate toward the cathode layer 10.

Accordingly, in the all-solid secondary battery, lithium may be used as the anode active material. In addition, since the metal layer is covered by the anode active material layer 22, the anode active material layer 22 may function as a protective layer of the metal layer, while inhibiting precipitation and growth of dendrites. Accordingly, short circuits and capacity fading in the all-solid secondary battery may be efficiently inhibited, and as a result, cycle characteristics of the all-solid secondary battery may improve. In addition, if a metal layer is to be disposed by charging after assembly of the all-solid secondary battery, the anode current collector 21, the anode active material layer 22, and the area therebetween may be Li-free regions not containing lithium, e.g., in the initial state or discharged state of the all-solid secondary battery.

[Anode Layer: Anode Current Collector]

The anode current collector 21 may be composed of a material that does not react with lithium, e.g., a material that does not form an alloy or a compound with lithium. The material forming the anode current collector 21 may be, e.g., copper (Cu), stainless steel, titanium (Ti), iron (Fe), cobalt (Co), nickel (Ni), and the like. The anode current collector 21 may be composed of one of the aforementioned metals or an alloy of two or more metals, or a coating material. The anode current collector 21 may be, e.g., a plate shape or a foil shape.

The all-solid secondary battery may further include, e.g., a thin film containing an element that forms an alloy with lithium on the anode current collector 21. The thin film may be positioned between the anode current collector 21 and the anode active material layer 22. The thin film may include, e.g., an element capable of forming an alloy with lithium. The element capable of forming an alloy with lithium may be, e.g., gold, silver, zinc, tin, indium, silicon, aluminum, bismuth, or the like. The thin film may be composed of one of the aforementioned metals or may be composed of an alloy of various kinds of metals. When the thin film is disposed on the anode current collector 21, for example, the precipitation form of the second anode active material layer being precipitated between a thin film 24 and the anode active material layer 22 may be further flattened, and thus cycle characteristics of the all-solid secondary battery may further improve.

A thickness of the thin film may be, e.g., from about 1 nm to about 800 nm, about 10 nm to about 700 nm, about 50 nm to about 600 nm, or about 100 nm to about 500 nm. If the thickness of the thin film is less than 1 nm, it may be difficult to achieve functions attributable to the thin film. If the thickness of the thin film is excessively large, the thin film itself absorbs lithium, causing a decrease in the precipitation amount of lithium at the anode, and therefore the energy density of the all-solid battery may be decreased, and cycle characteristics of the all-solid secondary battery may be decreased. The thin film may be positioned on the anode current collectors 21 by a vacuum deposition method, a sputtering method, a plating method or the like.

[Elastic Sheet]

The all-solid secondary battery may further include the first elastic sheet 50a and the second elastic sheet 50b, which are contiguous with the first anode current collector 21a and the second anode current collector 21b provided at both ends of the all-solid secondary battery, respectively. The first elastic sheet 50a and the second elastic sheet 50b may be formed of an elastic material.

The elastic material may include e.g., at least one of polyurethane, natural rubber, spandex, butyl rubber (Isobutylene Isoprene Rubber, IIR), fluoroelastomer, elastomers, ethylene-propylene rubber (EPR), styrene-butadiene rubber (SBR), chloroprene, elastin, rubber epichlorohydrin, Nylon, terpene, isoprene rubber, polybutadiene, nitrile rubber, thermoplastic elastomer, silicone rubber, ethylene-propylene-diene rubber (EPDM), ethylene vinyl acetate (EVA), halogenated butyl rubber, neoprene, and copolymers thereof. Any material having elasticity may be used. According to an example, the elastic sheet may be formed of a urethane-based material, e.g., polyurethane.

Each elastic sheet may be compressed such that the thickness of the elastic sheet at installation is about 40% to about 90% relative to the initial thickness prior to compression. For example, each elastic sheet may be compressed such that the thickness of the elastic sheet at installation is about 50% to about 85% and more specifically, about 60% to about 80%, or about 65% to about 75% relative to the initial thickness prior to compression. In the above ranges, volume changes of the anode may be effectively absorbed, thereby facilitating charging/discharging of the all-solid battery.

A thickness of the elastic sheet may be determined within a range of about 200% to about 500% of the thickness of a lithium precipitate layer in the anode that is formed when charging the all-solid secondary battery. In the all-solid secondary battery, the thickness of the lithium precipitate layer in the anode may be determined proportionally to the current density in the cathode, i.e., the amount of lithium migrating from the cathode to the anode may determine the thickness of the lithium precipitate layer in the anode, and volume changes at the anode take place based thereon. Accordingly, the thickness of the elastic sheet may be determined so as to absorb such volume changes at the anode.

Accordingly, by having the thickness of the elastic sheet being within a range of about 200% to about 500% of the thickness of the lithium precipitate layer formed in the anode when charging the all-solid secondary battery, volume changes at the anode may be effectively absorbed. For example, the thickness of the elastic sheet may be within a range of about 250% to about 450%, e.g., in a range of about 300% to about 400% with respect to the thickness of the lithium precipitate layer formed in the anode when charging the all-solid secondary battery.

For example, the thickness of each elastic sheet may be determined within a range of about 50 μm to about 300 μm, and may be determined optionally as needed in such ranges as about 100 μm to about 150 μm, about 200 μm to about 300 μm, about 50 μm to about 100 μm, and the like.

As described above, when the elastic sheets are provided on the anode current collector, volume changes caused by Li deposition reactions used in the anode may be absorbed, thereby suppressing changes in the volume of the entire cell, and thus a stable lifetime may be provided.

Embodiments will be described in greater detail through the following examples and comparative examples. However, it will be understood that the examples are provided only to illustrate embodiments and not to be construed as limiting.

### Example 1

(Preparation of Anode Layer)

A SUS (stainless steel) foil having a thickness of 10 μm was prepared as an anode current collector. In addition, as anode active materials, carbon black (CB) particles having a primary particle diameter of about 30 nm, and silver (Ag) particles having an average particle diameter of about 60 nm were prepared.

Next, 4 g of mixture powder containing the CB and Ag particles mixed in a weight ratio of 3:1 was placed in a vessel, and then 4 g of an NMP solution containing 7 wt % of PVDF binder (Kureha Co. #9300) was added to the vessel to thereby form a mixed solution. Then, while gradually adding NMP to this mixed solution, the mixed solution was agitated to form a slurry. The prepared slurry was coated onto the SUS sheet using a bar coater and was allowed to dry in open air at 80° C. for 10 minutes. The laminate thus obtained was vacuum-dried at a temperature of 40° C. for 10 hours. The dried laminate was roll-pressed at a pressure of 5 ton·f/cm² and a rate of 5 m/sec at room temperature, to thereby flatten the surface of an anode active material layer of the laminate. By following this process, an anode layer was prepared. The thickness of the anode active material layer included in the anode layer was about 7 μm. The size of the anode active material layer was 50 mm×76.5 mm, and the size of the anode current collector, excluding anode terminal portions, was identical to the area of the anode active material layer. Two such anode layers were prepared.

(Preparation of Cathode Layer)

LiNi_{0.8}Co_{0.15}Mn_{0.05}O₂ (NCM) coated with Li₂O—ZrO₂ (LZO) was prepared as a cathode active material. LZO-coated cathode active material was prepared following the process disclosed in Korean Patent No. 10-2016-0064942. Argyrodite-type crystals Li₆PS₅Cl (D50=0.6 μm, crystalline) were prepared as a solid electrolyte. A polytetrafluoroethylene (PTFE) binder (DUPONT, TEFLON binder) was prepared as a binder. Carbon nanofibers (CNFs) were prepared as a conducting agent. These materials were mixed at a weight ratio of cathode active material:solid electrolyte:conducting agent=84:11.5:3:1.5 with xylene as solvent, and the resulting mixture was molded in the form of a sheet, and the sheet was vacuum-dried at 40° C. for 8 hours to prepare a cathode sheet. The cathode sheet was placed on both sides of a cathode current collector formed of a carbon-coated aluminum foil and then was subjected to heated roll press at a pressure of 5 ton·f/cm² and a rate of 5 m/sec to prepare a cathode layer. The total thickness of the cathode layer was about 206 μm. The thickness of each cathode active material layer was about 96 μm and the thickness of the carbon-coated aluminum foil was about 12 μm. The size of the cathode active material layer was 47.6 mm×74.1 mm, and the size of the anode current collector, excluding a cathode terminal portion, was identical to the area of the cathode active material layer. In addition, the width of the exposed portion of the cathode active material layer pushed toward the cathode terminal portion was 0.7 mm.

(Preparation of Solid Electrolyte Layer)

In argyrodite-type crystal Li₆PS₅Cl solid electrolyte (D₋₅₀=3.0 mm, crystalline), 1.5 parts by weight of an acryl-based binder with respect to 98.5 parts by weight of the solid electrolyte was added to prepare a mixture. The prepared mixture, while adding octyl acetate thereto, was agitated to prepare a slurry. The prepared slurry was coated onto a nonwoven fabric (thickness 15 μm, porosity 90-95%) placed on a release film (PET, thickness 75 μm) using a bar coater, and was allowed to dry in the air at a temperature of 80° C. for 10 minutes, to prepare a laminate. The laminate thus obtained was vacuum-dried at a temperature of 80° C. for 2 hours. By following this process, a solid electrolyte layer was prepared. Two such solid electrolyte layers were prepared. The solid electrolyte layer was separated from the PET substrate before use. The size of the solid electrolyte layer was 52 mm×78.5 mm.

(Flame-retardant Inactive Member)

A slurry obtained by mixing cellulose fibers, glass fibers, aluminum hydroxide (Al(OH)₃), an acryl-based binder, and a solvent was molded in the form of a gasket, and then the solvent was removed therefrom to prepare a flame-retardant inactive member.

The weight ratio of cellulose fibers:glass fibers:aluminum hydroxide (Al(OH)₃):acryl-based binder was 20:8:70:2. The thickness of the flame-retardant inactive member was 120 μm. The shape of the flame-retardant inactive member was as illustrated as FIG. 5A and FIG. 5B. The outer size (w×1) of the flame-retardant inactive member was 52 mm×78.5 mm, the width (T1) of an uncoated portion corresponding portion of a first side portion, which is the shorter side, was 3.0 mm, the width (t1) of the remaining portion was 2.4 mm, and the width of a second side portion, which is the longer side, was 2.0 mm. The prepared flame-retardant inactive member was left at room temperature for 1 week before use.

(Preparation of Bi-Cell all-Solid Secondary Battery)

Referring to FIG. 3 and FIG. 4, on top of the solid electrolyte layer in the anode layer/solid electrolyte layer stack, the flame-retardant inactive member was pressed as a gasket by thermal press, to form an anode layer/solid electrolyte layer/flame-retardant inactive member stack. This stack was then stacked with the cathode layer, such that the cathode layer was positioned in the center of the solid electrolyte layer while the outer edge of the cathode layer was surrounded by the flame-retardant inactive member.

The resulting stack was placed in a heated plate press and pressed, and the prepared stack was plate press-treated at 85° C. at a pressure of 500 Mpa for 30 minutes, to prepare a laminated cell.

At the anode and cathode uncoated portions of the pressed laminated cell, an Ni tab and an Al tab were welded, respectively, and a 200 μm-thick elastic sheet made of a polyurethane material (Rogers Corp. PORON microcellular #6040) was attached to each anode layer, and the resulting pressed laminated cell was then placed in an Al pouch and hermetically sealed, to prepare a C-type bi-cell all-solid secondary battery. Parts of the cathode current collector and the anode current collector were taken out of the sealed battery and used as a cathode layer terminal and an anode layer terminal.

### Example 2

An all-solid secondary battery was prepared following the same process as described in Example 1, except that in the first side portion of the flame-retardant inactive member, the width (T1) of the uncoated portion corresponding portion was changed to 4.0 mm, the width (t1) of the remaining portion was changed to 2.4 mm, and the width of the second side portion, which is the longer side, was changed to 2.0 mm.

### Example 3

An all-solid secondary battery was prepared following the same process as described in Example 1, except that in the first side portion of the flame-retardant inactive member, the width (T1) of the uncoated portion corresponding portion was changed to 5.0 mm, the width (t1) of the remaining portion was changed to 2.4 mm, and the width of the second side portion, which is the longer side, was changed to 2.0 mm.

### Comparative Example 1

An all-solid secondary battery was prepared following the same process as described in Example 1, except in the first side portion of the flame-retardant inactive member, the width (T1) of the uncoated portion corresponding portion was changed to 5.0 mm, the width (t1) of the remaining portion was changed to 2.4 mm, and the width of the second side portion, which is the longer side, was changed to 2.0 mm.

### Comparative Example 2

An all-solid secondary battery was prepared following the same process as described in Example 1, except in the first side portion of the flame-retardant inactive member, the width (T1) of the uncoated portion corresponding portion was changed to 6.0 mm, the width (t1) of the remaining portion was changed to 2.4 mm, and the width of the second side portion, which is the longer side, was changed to 2.0 mm.

### Comparative Example 3

An all-solid secondary battery was prepared following the same process as described in Example 1, except in the first side portion of the flame-retardant inactive member, the width (T1) of the uncoated portion corresponding portion was changed to 3.0 mm, the width (t1) of the remaining portion was changed to 3.0 mm, and the width of the second side portion, which is the longer side, was changed to 3.0 mm.

### Comparative Example 4

An all-solid secondary battery was prepared following the same process as described in Example 1, except in the first side portion of the flame-retardant inactive member, the width (T1) of the uncoated portion corresponding portion was changed to 4.0 mm, the width (t1) of the remaining portion was changed to 4.0 mm, and the width of the second side portion, which is the longer side, was changed to 4.0 mm.

### Comparative Example 5

An all-solid secondary battery was prepared following the same process as described in Example 1, except that the exposed portion of the cathode active material layer pushed toward the cathode terminal portion had a width of 0.5 mm, and in the first side portion of the flame-retardant inactive member, the width (T1) of the uncoated portion corresponding portion was changed to 1.0 mm, the width (t1) of the remaining portion was changed to 1.0 mm, and the width of the second side portion, which is the longer side, was changed to 1.0 mm.

### Comparative Example 6

An all-solid secondary battery was prepared following the same process as described in Example 1, except that the exposed portion of the cathode active material layer pushed toward the cathode terminal portion had a width of 0.1 mm, and in the first side portion of the flame-retardant inactive member, the width (T1) of the uncoated portion corresponding portion was changed to 0.5 mm, the width (t1) of the remaining portion was changed to 0.5 mm, and the width of the second side portion, which is the longer side, was changed to 0.5 mm.

### Comparative Example 7

An all-solid secondary battery was prepared following the same process as described in Example 1, except that an insulating tape was applied to the cathode uncoated portion, there was no exposed portion of the cathode active material layer pushed toward the cathode terminal portion, and no flame-retardant inactive member was applied.

### Comparative Example 8

An all-solid secondary battery was prepared following the same process as described in Example 1, except that an insulating tape was applied to the cathode uncoated portion, the exposed portion of the cathode active material layer pushed toward the cathode terminal portion had a width of 0.5 mm, and in the first side portion of the flame-retardant inactive member, the width (T1) of the uncoated portion corresponding portion was changed to 2.0 mm, the width (t1) of the remaining portion was changed to 2.0 mm, and the width of the second side portion, which is the longer side, was changed to 2.0 mm.

### Evaluation Example 1: Evaluation of Difficulty in Member Stacking Process

Examples 1 and 2, and Comparative Examples 1 to 8 were evaluated for difficulty in the stacking process of the flame-retardant inactive member, and the results thereof are tabulated in Table 1 below. The symbols used in Table 1 are as follows: Low difficulty o, Medium difficulty A, and High difficulty X.

### Evaluation Example 2: Energy Density Evaluation

Energy densities per volume of the all-solid secondary batteries prepared in Examples 1 and 2 and Comparative Examples 1 to 8 (Capacity*Average voltage/Volume=Ah*V/L=Wh/L) were evaluated by relative volume difference, and the results thereof are shown in Table 1.

### Evaluation Example 3: Charge/Discharge Test

Charge/discharge characteristics of the all-solid secondary batteries prepared in Examples 1 and 2, and Comparative Examples 1 to 8 were evaluated by the following charge/discharge test. The charge/discharge testing was conducted by placing the all-solid secondary batteries in a constant-temperature chamber at 45° C.

During the first cycle, the all-solid secondary batteries were charged with a constant current of 27 mA/cm² for 12.5 hours until the battery voltage was 3.9 V to 4.25 V. Then, the all-solid secondary batteries were discharged at a constant current of 27 mA/cm² for 12.5 hours until the battery voltage was 2.5 V.

The discharge capacity of the first cycle was used as a standard capacity. From the second cycle onwards, charging and discharging under the same conditions as the first cycle were repeated up to 150 cycles.

The points in time at which a short-circuit occurred over the charging/discharging process were shown in Table 1.

TABLE 1

| | Cathode uncoated portion | | Flame-retardant inactive member | | | | | | |
|---|---|---|---|---|---|---|---|---|---|
| | | Active material | (Inactive member) | | | | Evaluation | | |
| | | exposed portion | | Width | | | Member | | Short- |
| | Insulating | t12a | Default | T1 | t1 | t2 | Stacking | Energy | circuit |
| | tape | (mm) | Applied | (mm) | (mm) | (mm) | process | density(%) | event |
| Ex. 1 | Not applied | 1.0 | Applied | 3.0 | 2.4 | 2.0 | ◯ | 100% | >100 |
| Ex. 2 | Not applied | 1.0 | Applied | 4.0 | 2.4 | 2.0 | ◯ | 100% | >100 |
| Comp. Ex. 1 | Not applied | 1.0 | Applied | 5.0 | 2.4 | 2.0 | ◯ | 98% | >100 |
| Comp. Ex. 2 | Not applied | 1.0 | Applied | 6.0 | 2.4 | 2.0 | ◯ | 95% | >100 |
| Comp. Ex. 3 | Not applied | 1.0 | Applied | 3.0 | 3.0 | 3.0 | ◯ | 95% | >100 |
| Comp. Ex. 4 | Not applied | 1.0 | Applied | 4.0 | 4.0 | 4.0 | ◯ | 93% | >100 |
| Comp. Ex. 5 | Not applied | 0.5 | Applied | 1.0 | 1.0 | 1.0 | X | 103% | 70th Charging |
| Comp. Ex. 6 | Not applied | 0.1 | Applied | 0.5 | 0.5 | 0.5 | X | 105% | 50th Charging |
| Comp. Ex. 7 | Applied | — | Not applied | — | — | — | — | 110% | 1st Charging |
| Comp. Ex. 8 | Applied | 0.5 | Applied | 2.0 | 2.0 | 2.0 | ◯ | 100% | 31st Charging |

Referring to the results in Table 1, as shown in Examples 1-2 and Comparative Example 1-2, where the width (T1) of the uncoated portion corresponding portion of the flame-retardant inactive member was extended to 3.0 mm to 6.0 mm, if Ti is increased, processability of the member improves gradually. However, T1 exceeding 4.0 mm causes a tab welding area to be pushed and accordingly, increases dead volume, thus leading to a decrease in energy density. Therefore, in terms of energy density, T1>4 mm is not preferable. In Comparative Examples 4-5, the overall width of the member was increased. When T1=t1=t2=3−4, the member stacking process was satisfactory, but energy density was reduced, and therefore this is not preferable either. In terms of energy density, it is more preferable if t2 is smaller. However, if t2 is as small as 2.0 mm or less, as in Comparative Examples 5-6, it may result in functional degradation of the member, that is, processing defects due to steps between the cathode layer and the solid electrolyte layer. In such cases, there may be some increase in energy density, but stack processability of the member may suffer and a short circuit may occur earlier during lifetime.

Comparative Example 7 where an insulating tape is applied to the cathode uncoated portion and the member is not applied, may show better energy density compared to when the member is applied, but as a short circuit occurred during the first charging, the lifetime evaluation was made impossible. Comparative Example 8 is the same as Comparative Example 7 except that the member was applied without differing in the shape of the member which is used in Example 1. In this case, due to the insulating tape on the uncoated portions and subsequently stress at the tab welding portion, a short circuit occurred during its lifetime, during charging/discharging.

Since an all-solid secondary battery containing a sulfide-based solid electrolyte requires a certain compression during the manufacturing process and charge/discharge testing, physical defects and non-uniformity inside a cell may act as a cause of a short circuit. From the results above, it could be confirmed that incorporation of the member of a certain shape shows an effect of improving short circuits, as well as stack processibility of the member, energy density, and longevity. As described above, the all-solid secondary battery associated with the present examples may be applied to a variety of portable devices, vehicles, and the like.

According to one aspect of embodiments, provided is an all-solid secondary battery including: a cathode layer; an anode layer; and a solid electrolyte layer between the cathode layer and the anode layer, wherein the cathode layer includes a cathode current collector and a cathode active material layer positioned on one side or both sides of the cathode current collector and here, the cathode current collector further includes a cathode uncoated portion composed of an exposed portion of the cathode current collector without the cathode active material layer disposed thereon, wherein the anode layer includes an anode current collector and an anode active material layer disposed on the anode current collector and here, the anode current collector further includes an anode uncoated portion composed of an exposed portion of the anode current collector without the anode active material layer disposed thereon, the all-solid secondary battery further including a flame-retardant inactive member which is located on and in contact with the solid electrolyte layer and is in a rectangular enclosure shape surrounding side surfaces of the cathode active material layer, wherein the flame-retardant inactive member includes a pair of first side portions, each having an uncoated portion corresponding portion corresponding to the cathode uncoated portion and the anode uncoated portion, and a pair of second side portions connected to the first side portions, wherein in the first side portion, a width of the uncoated portion corresponding portion is greater than a width of the remaining portion of the uncoated portion corresponding portion.

By way of summation and review, all-solid secondary batteries may contain sulfide-based solid electrolyte, so densification of the solid electrolyte and conductivity of electrons and ions at interfaces with electrode plates may be ensured by uniform compaction of a unit cell in which cathode/solid electrolyte/anode are stacked. However, since sulfide-based all-solid secondary batteries require a certain compression during the manufacturing process and charge/discharge testing, physical defects and non-uniformity within a cell may cause a short circuit.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated.

Accordingly, it will be understood by those of skill in the art that various changes in form and details may be made without departing from the spirit and scope of the present invention as set forth in the following claims.

What is claimed is:

1. An all-solid secondary battery, comprising:
a cathode layer including a cathode current collector and a cathode active material layer on at least one surface of the cathode current collector, the cathode current collector having a cathode uncoated portion composed of an exposed portion of the cathode current collector without the cathode active material layer disposed thereon;
an anode layer including an anode current collector and an anode active material layer on the anode current collector, the anode current collector having an anode uncoated portion composed of an exposed portion of the anode current collector without the anode active material layer disposed thereon;
a solid electrolyte layer between the cathode layer and the anode layer; and
a flame-retardant inactive member on and in contact with the solid electrolyte layer, the flame-retardant inactive member having a rectangular enclosure shape surrounding side surfaces of the cathode active material layer,
wherein the flame-retardant inactive member includes a pair of first side portions having protruding portions corresponding to the cathode uncoated portion and the anode uncoated portion, respectively, and a pair of second side portions connected to the first side portions, a width of each of the protruding portions being greater than a width of a remaining portion of each of the pair of first side portions.

2. The all-solid secondary battery as claimed in claim 1, wherein a length of each of the pair of second side portions is greater than a length of each of the pair of first side portions.

3. The all-solid secondary battery as claimed in claim 1, wherein the cathode layer further includes a protruded portion of the cathode active material layer extending onto the cathode uncoated portion.

4. The all-solid secondary battery as claimed in claim 3, wherein a width of the protruded portion is about 0 mm to about 1 mm.

5. The all-solid secondary battery as claimed in claim 1, wherein a first gap between one of the pair of first side portions of the flame-retardant inactive member and the cathode active material layer is about 0 mm to about 1 mm, and a second gap between one of the pair of second side portions of the flame-retardant inactive member and the cathode active material layer is about 0 mm to about 0.5 mm.

6. The all-solid secondary battery as claimed in claim 1, wherein the width of each of the protruding portions is about 1 mm to about 4.5 mm.

7. The all-solid secondary battery as claimed in claim 1, wherein a width of each of the pair of second side portions of the flame-retardant inactive member is smaller than the width of the protruding portion of the flame-retardant inactive member, and is smaller than or equal to the width of the remaining portion of each of the pair of first side portions.

8. The all-solid secondary battery as claimed in claim 7, wherein, in each of the pair of first side portions, the width of the remaining portion of each of the pair of first side portions is about 0.5 mm to about 4 mm, and the width of each of the pair of second side portions is about 0.5 mm to about 3 mm.

9. The all-solid secondary battery as claimed in claim 1, wherein the pair of first side portions and the pair of second side portions of the flame-retardant inactive member are coupled to each other into the rectangular enclosure shape, the rectangular enclosure shape including a rectangular gasket shape.

10. The all-solid secondary battery as claimed in claim 9, wherein each of the pair of first side portions includes two corner portions of the rectangular enclosure shape of the flame-retardant inactive member at opposite ends thereof, respectively.

11. The all-solid secondary battery as claimed in claim 10, wherein a width of each of the opposite ends is greater than a width of the remaining portion of each of the pair of first side portions excluding the protruding portion.

12. The all-solid secondary battery as claimed in claim 10, wherein each of a first gap between each of the pair of first side portions and the cathode active material layer, and a second gap between each of the pair of second side portions and the cathode active material layer is more than 0 mm and less than 0.3 mm.

13. The all-solid secondary battery as claimed in claim 1, wherein a size of the solid electrolyte layer is smaller than an outer size of the rectangular enclosure shape of the flame-retardant inactive member and greater than an inner size of the rectangular enclosure shape of the flame-retardant inactive member.

14. The all-solid secondary battery as claimed in claim 13, wherein the size of the solid electrolyte layer occupies 50% or more of a width of each of the pair of first side portions and the pair of second side portions of the flame-retardant inactive member.

15. The all-solid secondary battery as claimed in claim 1, wherein the flame-retardant inactive member includes a matrix and a filler.

16. The all-solid secondary battery as claimed in claim 15, wherein:
the matrix includes a substrate and a reinforcing material,
the substrate includes a first fibrous material, the first fibrous material being an insulating material, and the first fibrous material including one or more selected from among pulp fibers, insulating polymer fibers, and ion conductive polymer fibers, and
the reinforcing material includes a second fibrous material, the second fibrous material being a flame-retardant material, and the second fibrous material including one or more selected from among glass fibers, metal oxide fibers, and ceramic fibers.

17. The all-solid secondary battery as claimed in claim 15, wherein:
the filler is a moisture getter, and
the filler includes a metal hydroxide and the metal hydroxide includes one or more selected from among Mg(OH)₂, Fe(OH)₃, Sb(OH)₃, Sn(OH)₄, TI(OH)₃, Zr(OH)₄, Al(OH)₃.

18. The all-solid secondary battery as claimed in claim 1, wherein the cathode layer and the anode layer are disposed such that the cathode uncoated portion and the anode uncoated portion are facing an opposite direction from each other.

19. The all-solid secondary battery as claimed in claim 1, wherein:
the cathode layer further includes an additional cathode active material layer, the cathode active material layer and the additional cathode active material layer being on opposite sides of the cathode current collector,
the solid electrolyte layer includes a first solid electrolyte layer and a second solid electrolyte layer, which are contiguous with the cathode active material layer and the additional cathode active material layer, respectively,
the anode layer includes an additional anode active material layer, the anode active material layer and the additional anode active material layer being contiguous with the cathode active material layer and the additional cathode active material layer, respectively; and a first anode current collector and a second anode current collector, which are contiguous with the anode active material layer and the additional anode active material layer, respectively,
the flame-retardant inactive member includes a first flame-retardant inactive member and a second flame-retardant inactive member, which are disposed to surround side surfaces of the cathode active material layer and the additional cathode active material layer, respectively, between the first solid electrolyte layer and the second solid electrolyte layer, and
the cathode layer and the anode layer are disposed, such that the cathode uncoated portion of the cathode current collector, and anode uncoated portions of the first anode current collector and the second anode current collector are facing opposite directions from each other.

20. The all-solid secondary battery as claimed in claim 19, further comprising a first elastic sheet and a second elastic sheet, which are contiguous with the first anode current collector and the second anode current collector, respectively.
